(19) United States
(12) Patent Application Publication
(10) Pub. No.: US 2013/0105487 A1
(43) Pub. Date: May 2, 2013

(54) WASTEBASKET EQUIPPED WITH ROLL VINYL PACK

(71) Applicant: Seoung Yub Baik, Seongnam-si (KR)

(72) Inventor: Seoung Yub Baik, Seongnam-si (KR)

(21) Appl. No.: 13/261,483

(22) PCT Filed: Apr. 22, 2011
(86) PCT No.: PCT/KR2011/002946

§ 371 Date: Jan. 9, 2013

(30) Foreign Application Priority Data
Apr. 28, 2010 (KR) 20-2010-0004480
Oct. 5, 2010 (KR) 10-2010-0096642

(51) Int. Cl. B65F 1/06

(52) U.S. Cl. CPC B65F 1/062
USPC 220/495.07

(57) ABSTRACT

The present invention relates to a wastebasket equipped with a roll vinyl pack. More specifically, for the purpose of simply and conveniently changing a roll vinyl pack installed in a wastebasket and maximizing the use of a space by preventing a space capable of storing garbage from being reduced because of the roll vinyl pack, the invention provides a wastebasket comprising: a body which has an upper end opened to accommodate garbage, and is formed with a space on an inner side thereof; a mounting unit which is formed on one side of the body, and is mounted with a roll vinyl pack; and a hook which is installed on the bottom surface of the body in order to guide a vinyl bag taken out of the roll vinyl pack so that the guided bag is unfolded on the body.

### TECHNICAL FIELD

The present invention relates to a wastebasket equipped with a roll vinyl pack wherein the roll vinyl pack installed inside the wastebasket to collect wastes is provided at a side of the wastebasket thus enabling an easy replacement of the roll vinyl pack.

### BACKGROUND ART

Generally, garbage is first thrown into a vinyl bag or standard garbage bag and then discarded into a dumpster for sanitary reason and convenient discharge of wastes. Since the wastes are discarded after tying up the open end of the vinyl bag or standard garbage bag it helps to maintain a secured sanitary living environment.

As a more improved technology in the art, Korean Utility Application Publication No. 20-1994-0009972 discloses a wastebasket which includes: a supporting bump (1a), which supports a supporting member (2) having a lifting groove (2a) for taking out vinyl bags, is formed at a predetermined lower end of the body (1) of a wastebasket with a groove (1d); a steel-faced vinyl fixing recess (3a), which is aligned with the groove (1d) of the wastebasket; a pressing plate (3) having a handle groove (3b); and a winding shaft (1c), which winds vinyl bags for accommodating garbage, being fixed on a shaft supporting groove (1b), which is formed on the body (1) of the wastebasket.

However, the traditional wastebasket had a disadvantage that the process of replacing vinyl bags is not convenient and cumbersome. For example, in order to change the vinyl bags, the winding shaft must be first removed laterally, a roll pack which wound up vinyl bags are lifted above the wastebasket to separate therefrom, a new vinyl roll pack is inserted into the winding shaft, the roll pack is placed into the bottom part of the wastebasket and then the winding shaft is inserted into the shaft supporting groove.

Further, the roll pack is installed in the inner lower part of the wastebasket requiring a marginal space for the roll pack the storage capacity to accommodate garbage is limited. In addition, the width and the size of the wastebasket are already determined a roll pack with a suitable size must be purchased thus requiring special attention in its purchase.

Further, the conventional technology was not efficient in terms of utilizing space efficiency because the space inside the wastebasket is overly reduced due to the presence of the roll pack installing space even when the roll pack is not in use.

### SUMMARY OF INVENTION

### Technical Problem

The present invention has been made in an effort to solve the above-described problems associated with prior art, and provides an improved wastebasket equipped with a roll vinyl pack, which has a simple structure thus enabling the process of changing roll vinyl packs very concise and convenient.

The present invention also provides a wastebasket equipped with a roll vinyl pack which can maximize its space efficiency by preventing the space for accommodating garbage from being reduced.

### Technical Solution

In an effort to achieve the above goal the wastebasket prepared according to the present invention includes a body (10) which has an upper end opened to accommodate garbage, and is formed with a space on an inner side thereof; a mounting unit (200) which is formed on one side of the body, and is mounted with a roll vinyl pack (30); and a hook (14) which is installed on the bottom surface of the body in order to guide a vinyl bag (31) taken out of the roll vinyl pack (30), so that the guided bag is unfolded on the body.

### Advantageous Effects of Invention

According to an embodiment of the present invention, there is provided a hook formed on the bottom surface of the body of a wastebasket, which enables to easily and conveniently hang the vinyl taken out of a roll vinyl pack and unfold it, and also the wastebasket itself has a very simple structure thereby reducing its manufacturing cost thus improving its competitiveness.

According to another embodiment of the present invention, there is provided a roll vinyl pack installed on the mounting unit provided at one side of the wastebasket thereby preventing a space capable of storing garbage from being reduced and also not preventing space efficiency.

According to a further embodiment of the present invention, the roll vinyl pack can be easily detached or attached by simply lifting or inserting the roll vinyl pack thus enabling easy replacement of the same. Further, the roll vinyl pack can be easily installed regardless of its size or length and thus it provides a wide selection.

### BRIEF DESCRIPTION OF DRAWINGS

FIG. 1 is a perspective view of a wastebasket according to a first embodiment of the present invention.

FIG. 2 is a plan view of a wastebasket according to a first embodiment of the present invention.

FIG. 3 is a sectional view along line A-A of FIG. 2.

FIG. 4 is a perspective view of a wastebasket according to a second embodiment of the present invention.

FIG. 5 is a sectional view of a wastebasket according to a second embodiment of the present invention.

FIG. 6 is a partially enlarged view of FIG. 5 according to a third embodiment, a modification of the second embodiment, of the present invention.

FIG. 7 is an enlarged view of a hook according to a fourth embodiment of the present invention.

FIG. 8 is a sectional view of a wastebasket according to a fifth embodiment of the present invention.

### DESCRIPTION OF EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention includes a body which has an upper end opened to accommodate garbage, and is formed with a space on an inner side thereof; a mounting unit which is formed on one side of the body, and is mounted with a roll vinyl pack; and a hook which is installed on the bottom surface of the body in order to guide a vinyl bag taken out of the roll vinyl pack, so that the guided bag is unfolded on the body.

Here, there is provided between the body and the mounting unit a longitudinal opening having a width smaller than the diameter of the roll vinyl pack.

Further, there is provided a wall between the body and the mounting unit which separates the inner part of the body and the mounting unit, wherein there is provided an aperture on the wall that guides the vinyl bag taken out of the roll vinyl pack into the interior of the body.

Further, there is further provided a rotating plate on the lower part of the supporting pole, which supports the roll vinyl pack by being in close contact with the lower end of the roll vinyl pack and enables to rotate it at the same time.

Still further, the waste basket equipped with a roll vinyl pack according to the present invention may further include a ring which is rotatable on the outer surface of the hook.

### DESCRIPTION OF EMBODIMENTS

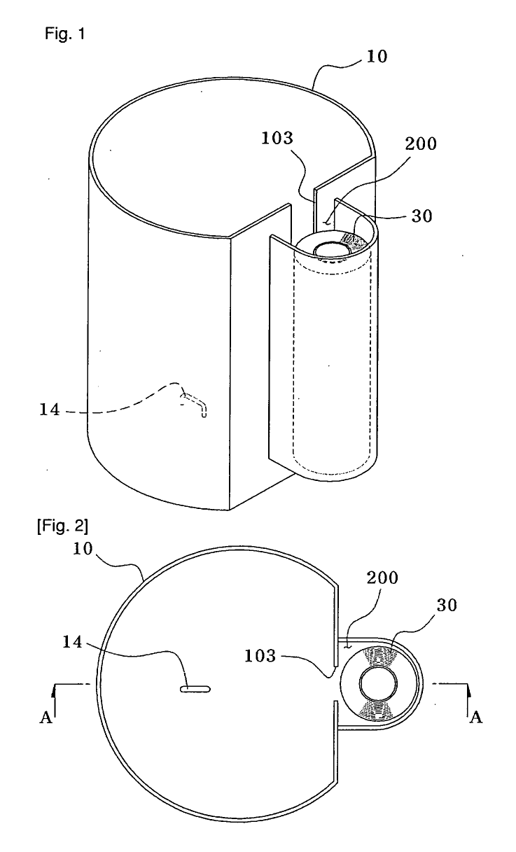

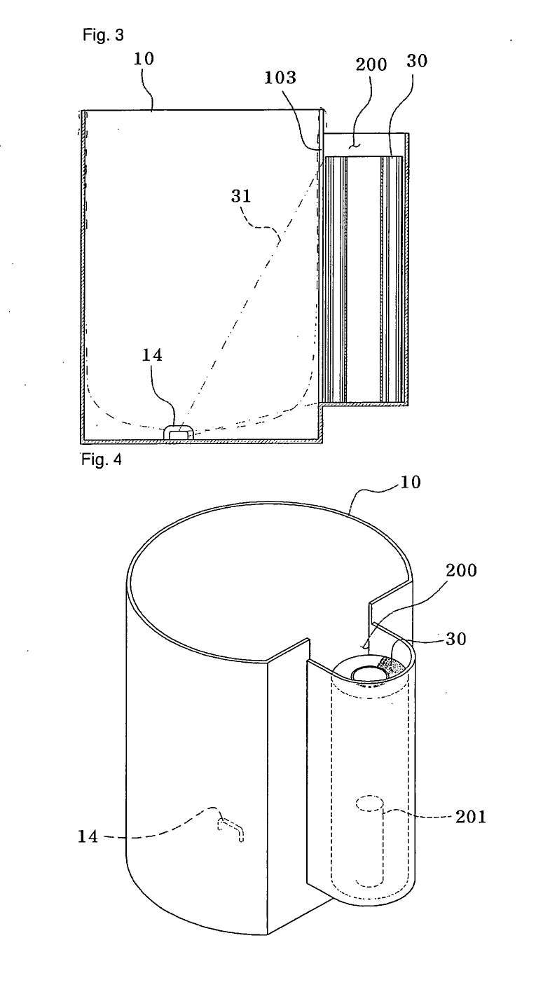

FIG. 1 is a perspective view of a wastebasket according to a first embodiment of the present invention, FIG. 2 is a plan view of a wastebasket according to a first embodiment of the present invention, and FIG. 3 is a sectional view along line A-A of FIG. 2.

As illustrated in FIGS. 1-3, according to a first embodiment of the present invention, a means for installing the roll vinyl pack (30) is installed at one side of the body (10) of the wastebasket.

The above body (10) is in the form of a basket with an open upper portion, and there is a space provided in its interior for the accommodation of wastes.

The above roll vinyl pack (30) is in the form of a conventional wound roll prepared by winding the vinyl bag (31), which is made to be cut off one by one for use.

The vinyl bag (31) is formed at one end of the body (10), wherein “one side” refers to an inner space of the body (10) or an additional space provided at one end of the inner space of the body (10).

The above roll vinyl pack (30) is, as described above, installed at a part of the inner space of the body (10) or an inner space of the body (10) and an additional space of the mounting unit (200.

Here, in the case the above mounting unit (200) refers to an inner space of the body (10) and an additionally provided space, there is preferably formed a wall between the space of the mounting unit (200) and the inner space of the body (10), and also there is preferably formed an opening (103) on the above wall, so that each of the above mentioned spaces can be connected therethrough.

Here, the movement of the roll vinyl pack (30) from the space of the mounting unit (200) to the space of the body (10) can be prevented by making the width of the above opening (103) smaller than the diameter of the roll vinyl pack (30).

On the lower part of the body (10) there is formed a hook (14).

Here, as shown in FIG. 3, the roll vinyl pack (30) is first installed on the space of the mounting unit (200), the roll vinyl pack (30) is unfolded so that a taken out vinyl bag (31) is guided into the opening (103), hung onto the hook (14) and unfolded onto the upper portion of the body (10), and the garbage discarded into the interior of the body (10) can be received into the vinyl bag (31).

Once the vinyl bag (31) is filled with garbage, each vinyl bag can be cut off along the perforated line (not shown) provided at predetermined intervals on the vinyl bag (31) and the garbage can be easily discharged.

Then, a fresh new vinyl bag (31) can be taken out of the roll vinyl pack (30) as the roll vinyl pack (30) rotates by pulling the perforated portion, and by unfolding the fresh vinyl bag (31) over the upper part of the body (10) it becomes ready to accommodate garbage.

According to a first embodiment of the present invention, in changing roll vinyl packs (30), it can be easily put into and taken out of the upper portion of the mounting unit (200), and also by simply hanging on the hook (14) a fresh vinyl bag (31) taken out of the roll vinyl pack (30) over the upper portion of the body (10) it becomes ready to be used thus being very convenient and easy to use.

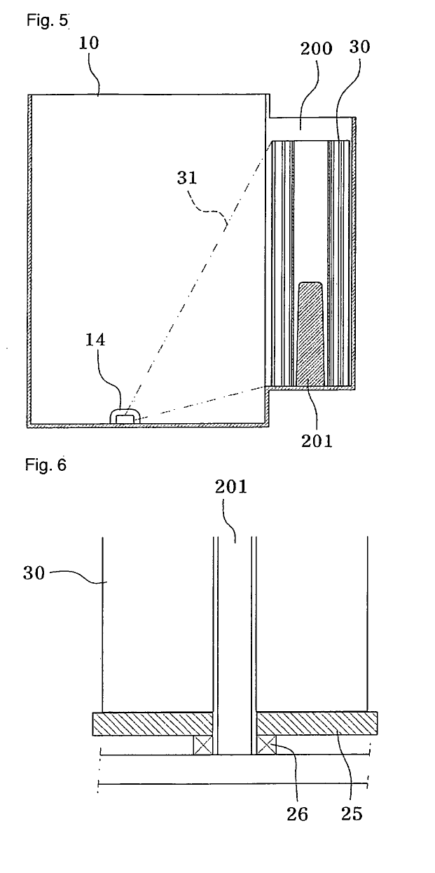

FIG. 4 shows a perspective view of the wastebasket according to the second embodiment of the present invention, and FIG. 5 shows a sectional view of the wastebasket according to the second embodiment of the present invention.

As illustrated in FIGS. 4-5, the mounting unit (200) is formed at one side of the body (10). Here, the space of the mounting unit (200) and the space of the body (10) can be mutually connected without a wall, and the roll vinyl pack (30) received into the mounting unit (200) can be fixed by a supporting pole (201), which is protruded upwardly from the lower part of the mounting unit (200).

In this modified embodiment of the present invention, the roll vinyl pack (30) will be prevented from moving into the interior of the body (10) due to the presence of a supporting pole (201) although the mounting unit (200) is formed on a part of the interior of the body (10). Therefore, there is no need to provide a wall between the mounting unit (200) and the body (10).

As such, the roll vinyl pack (30) installed on the supporting pole (201) is rotatably fixed in the space inside the mounting unit (200) and is thus prevented from being detached into the interior of the body (10), and the vinyl bag (31) taken out of the roll vinyl pack (30) is hung on the hook (14) mounted on the bottom of the lower part and unfolded over the upper portion of the body (10) thereby completing with ease the setting up of a vinyl bag (31).

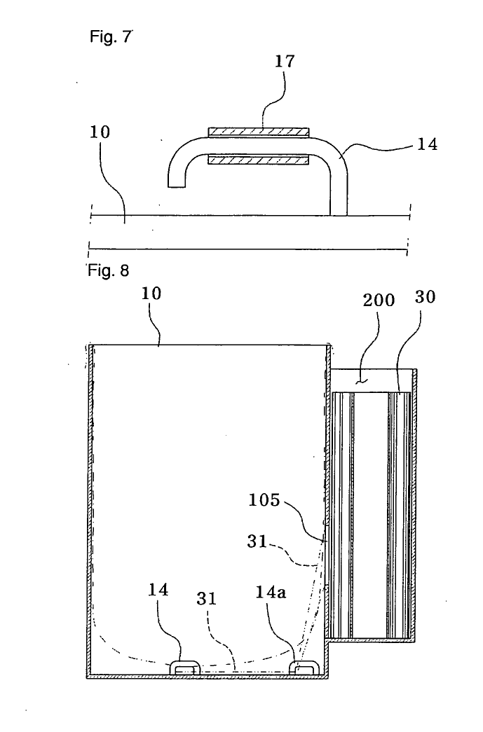

FIG. 6 is a partially enlarged view of FIG. 5 according to a third embodiment, a modification of the second embodiment, of the present invention.

As explained above, once the supporting pole (201) is installed on the mounting unit (200), as shown in FIG. 6, a rotatable rotating plate (25) can be installed. Here, bearings (26) may be installed between the above rotating plate (25) and the bottom surface of the mounting unit (200).

In the above case, the roll vinyl pack (30) becomes stably placed on the rotating plate (25). Therefore, once a vinyl bag (31) is pulled out it causes the roll vinyl pack (30) to rotate which again causes the rotating plate (25) to also rotate concurrently without generating any friction between the roll vinyl pack (30) and the bottom surface of the mounting unit (200). As a result, a vinyl bag (31) can be taken out smoothly out of the roll vinyl pack.

FIG. 7 is an enlarged view of a hook according to a fourth embodiment of the present invention.

As shown in FIG. 7, the above explained hook (14) may be provided with a ring (17) on its outer surface, and the ring (17) is an additional component apart from the hook (14) being rotatably installed on the outer surface of the hook (14).

Here, as a vinyl bag (31) is taken out the hook (14), which is in close contact with the vinyl bag (31), can also rotate and thus the vinyl bag (31) can be smoothly taken out.

FIG. 8 is a sectional view of a wastebasket according to a fifth embodiment of the present invention.

As shown in FIG. 8, a plurality of the hook (14) may be provided on the bottom surface of the body (10). Here, the hook (14) may be installed in a place in the central area of the bottom surface of the body (10) and may also be provided in a place adjacent to the mounting unit (200), i.e., a place close to where the roll vinyl pack (30) is installed.

In this case, the vinyl bag (31) taken out of the roll vinyl pack (30) is first hung onto the hook (14a) close to the roll vinyl pack (30), and then hung onto the hook (14) placed in the central area of the body (10). Therefore, it helps to reduce the space being occupied at the time of taking out a vinyl bag (31) thus enabling to provide more room for accommodating more garbage.

Further, in the case when the interior space of the body (10) and the space of the mounting unit (200) is separated by means of a wall, it is preferable to form an aperture on the above wall. Then, the vinyl bag (31) taken out of the roll vinyl pack (30) can be guided into the inside of the body (10) through the aperture (105), and the vinyl bag (31) guided into the inside of the body (10) can pass through one or more of hooks (14) installed and unfolded thereafter inside the body (10).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1-6. (canceled)

7. A wastebasket equipped with a roll vinyl pack, comprising:
a body which has an upper end opened to accommodate garbage, and is formed with a space on an inner side thereof;
a mounting unit which is formed on one side of the body, and is mounted with a roll vinyl pack; and
at least one hook which is installed on the bottom surface of the body in order to guide a vinyl bag taken out of the roll vinyl pack, so that the guided bag is unfolded on the body.

8. The wastebasket equipped with a roll vinyl pack according to claim 7, wherein there is provided between the body and the mounting unit a longitudinal opening having a width smaller than the diameter of the roll vinyl pack.

9. The wastebasket equipped with a roll vinyl pack according to claim 7, wherein there is provided a wall between the body and the mounting unit which separates the inner part of the body (10) and the mounting unit, wherein there is provided an aperture on the wall that guides the vinyl bag taken out of the roll vinyl pack into the interior of the body.

10. The wastebasket equipped with a roll vinyl pack according to claim 7, wherein there is provided a supporting pole on the bottom of the mounting unit which penetrates itself through the empty central space of the roll vinyl pack thereby enabling the vinyl pack to rotate.

11. The wastebasket equipped with a roll vinyl pack according to claim 10, wherein there is further provided a rotating plate on the lower part of the supporting pole, which supports the roll vinyl pack by being in close contact with the lower end of the roll vinyl pack and enables to rotate it at the same time.

12. The wastebasket equipped with a roll vinyl pack according to claim 7, further comprising a ring which is rotatable on the outer surface of the hook.
